(19) United States
(12) Patent Application Publication
(10) Pub. No.: US 2025/0391603 A1
(43) Pub. Date: Dec. 25, 2025

(54) Coil Device, Chip Capacitor Holder, And Method Of Manufacturing Coil Device

(71) Applicant: SUMIDA CORPORATION, Tokyo (JP)

(72) Inventors: Ryuhei HATA, Natori City (JP); Nobuyuki TAKAHASHI, Natori City (JP); Kenta CHIBA, Natori City (JP); Daichi GEMBA, Natori City (JP)

(21) Appl. No.: 19/306,127

(22) Filed: Aug. 21, 2025

Related U.S. Application Data
(63) Continuation of application No. PCT/JP2023/014739, filed on Apr. 11, 2023.

(51) Int. Cl. H01F 27/40; H01F 27/28; H01F 41/04

(52) U.S. Cl. CPC H01F 27/40; H01F 27/2823; H01F 41/04

(57) ABSTRACT

A coil device includes a coil and a chip capacitor. A coil wire is wound around the coil. The chip capacitor has an electrode surface. The electrode surface is electrically connected to the coil. A connecting portion is a partial length region of the coil wire extracted from the coil. The connecting portion is directly connected to the electrode surface.

### CROSS REFERENCE TO RELATED APPLICATIONS

This application is a continuation of International Patent Application No. PCT/JP2023/014739, filed on Apr. 11, 2023, which is expressly incorporated herein by reference in its entirety.

### BACKGROUND

### Technical Field

The present invention relates to a coil device, a chip capacitor holder, and a method of manufacturing such a coil device.

### Related Art

Some coil devices include chip capacitors. International Publication No. WO 2017/208828 (Patent Document 1) discloses a coil antenna (100) having a coil (3) and a chip-like capacitor (referred to as a chip capacitor (10)) that connects to the coil (3). One end of a coil wire extracted from the coil is soldered to a relay terminal (9b) that is integrally formed with a metal wiring (7c). In addition, the chip capacitor (10) is mounted on an electrode (8b) integrally formed with the metal wiring (7c) by soldering. In other words, one end of the coil (3) is indirectly connected to an electrode of the chip capacitor (10) via the relay terminal (9b), the metal wiring (7c) and the electrode (8b).

However, when one end of the coil (3) and the chip capacitor (10) are connected via one or a plurality of other members such as the metal wiring (7c), a problem arises in that the number of components required for manufacturing increases, the cost of manufacturing in order to connect the components increases, or an overall size of the coil device increases.

The present invention has been made in view of the problems described above and an object thereof is to provide a coil device capable of reducing the cost of manufacturing or capable of being downsized.

### SUMMARY

A coil device according to the present invention includes: a coil around which a coil wire is wound; and a chip capacitor which electrically connects to the coil and which has an electrode surface, wherein a connecting portion which is a partial length region of the coil wire extracted from the coil is directly connected to the electrode surface.

A chip capacitor holder according to the present invention includes: a mounting portion for mounting a chip capacitor; and a first side portion and a second side portion which are separated from and face each other across the mounting portion, wherein a notched portion is formed on an end surface of the first side portion, another notched portion is formed on an end surface of the second side portion, and the notched portion and the other notched portion overlap with each other when viewed in a separation direction of the first side portion and the second side portion.

A method of manufacturing a coil device according to the present invention is a method of manufacturing a coil device including: a coil around which a coil wire is wound; and a chip capacitor which electrically connects to the coil and which has an electrode surface, wherein the coil wire is extracted from the coil and a connecting portion which is a partial length region of the extracted coil wire is directly connected to the electrode surface.

Directly connecting a partial length region of the coil wire extracted from the coil to the electrode surface of the chip capacitor eliminates the need to use other members for connecting the coil wire and the chip capacitor to each other.

### Effect of the Invention

According to the coil device of the present invention, directly connecting the coil wire and the electrode surface of the chip capacitor to each other eliminates the need to use other members for connecting the coil wire and the chip capacitor to each other, eliminates the need to secure space for arranging the other members, and enables steps for arranging the other members and connecting the other members to the coil wire and the like to be omitted.

Accordingly, the cost of manufacturing the coil device may be reduced or the coil device may be downsized.

### BRIEF DESCRIPTION OF THE DRAWINGS

The object described above as well as other objects, features, and advantages will be further clarified by the preferred embodiments described below and the following accompanying drawings, in which:

FIG. 1 is a perspective view showing an example of a coil device according to a first embodiment of the present invention.

FIG. 2 is an exploded perspective view of the coil device according to the first embodiment.

FIG. 3 is a front view of the coil device according to the first embodiment, in which contours of a coil, a coil wire, and a chip capacitor are indicated by dotted lines.

FIG. 4 is a top view of the coil device according to the first embodiment.

FIG. 5 is a bottom view of the coil device according to the first embodiment.

FIG. 6 is a right view of the coil device according to the first embodiment, in which contours of a coil wire and a chip capacitor are indicated by dotted lines.

FIG. 7 is a longitudinal sectional view of a cross section along a dashed-dotted line shown in FIG. 3 of the coil device according to the first embodiment as viewed in a direction of an arrow VII-VII.

FIG. 8A is an enlarged view of a first arrangement portion and a vicinity thereof in a top view of a coil device according to a second embodiment.

FIG. 8B is an enlarged view of a first arrangement portion and a vicinity thereof in a top view of a coil device according to a third embodiment.

### DETAILED DESCRIPTION

Various constituent elements of a coil device according to the present invention need not be individually independent entities. A plurality of constituent elements may be formed as a single member, a single constituent element may be formed by a plurality of members, a given constituent element may constitute a part of another constituent element, a part of a given constituent element and a part of another constituent element may overlap with each other, and the like.

In addition, while a method of manufacturing a coil device according to the present invention may be described using a plurality of sequentially described steps, the described sequence is not intended to limit a sequence or a timing of executing the plurality of steps. Therefore, when implementing the method of manufacturing a coil device according to the present invention, the sequence of the plurality of steps may be changed to the extent that such a change does not interfere with contents and a part of or all of the timings at which the plurality of steps are executed may overlap with each other.

Hereinafter, embodiments of the present invention will be described based on the drawings. In the respective drawings, corresponding constituent elements will be denoted by common reference signs and redundant descriptions will not be repeated.

In the present embodiments, descriptions will be given by defining directions of front, rear, left, right, up and down as shown. However, the directions are merely set for the sake of convenience for explaining correspondence relationships among the constituent elements in a simple manner and are not intended to limit directions during manufacture or during use of products that implement the present invention. In the present embodiments, a front-rear direction coincides with a winding axis direction of a coil, a left-right direction coincides with a width direction of the coil device, and an up-down direction coincides with a thickness direction of the coil device.

Moreover, the term “flat surface” as used in the present invention means a shape having been physically formed with a flat surface as a goal and, obviously, the shape need not be geometrically perfectly flat.

### First Embodiment

### (Coil Device)

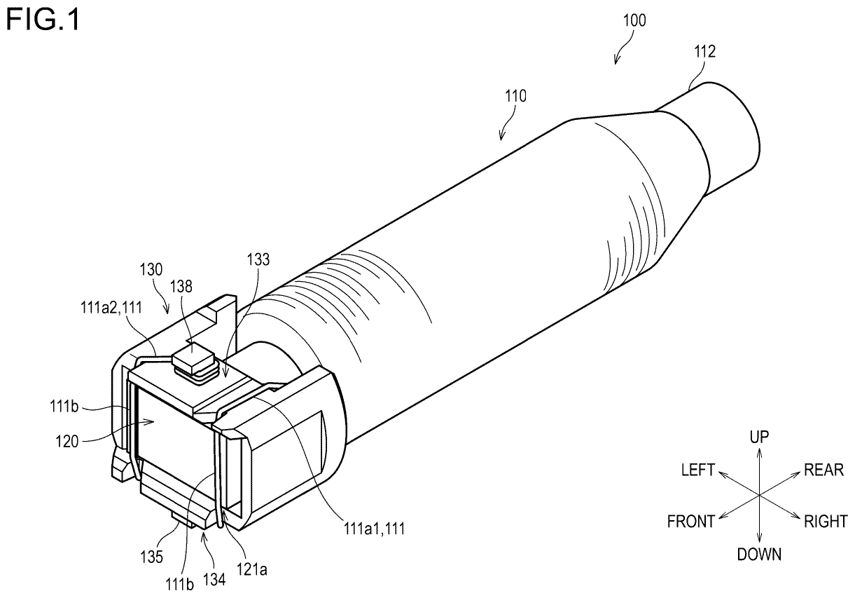

The present embodiment will be described with reference to FIGS. 1 to 7. In FIGS. 1, 2, 4, and 5, a brazing material 140 is not shown.

FIG. 1 is a perspective view showing an example of a coil device 100 according to a first embodiment of the present invention.

First, an overview of the coil device 100 according to the present embodiment will be described.

The coil device 100 includes a coil 110 and a chip capacitor 120. A coil wire 111 is wound around the coil 110. The chip capacitor 120 electrically connects to the coil 110 and has an electrode surface 121a. The electrode surface 121a is a surface of an electrode of the chip capacitor 120. A connecting portion 111b is a partial length region of the coil wire 111 extracted from the coil 110. The connecting portion 111b is directly connected to the electrode surface 121a.

Directly connecting the coil wire 111 and the electrode surface 121a of the chip capacitor 120 to each other eliminates the need to use other members (metal wiring and the like) for connecting the coil wire 111 and the chip capacitor 120 to each other, eliminates the need to secure space for arranging the other members, and enables steps for arranging the other members and connecting the other members to the coil wire 111 and the like to be omitted.

Accordingly, the coil device 100 may be readily manufactured, the cost of manufacturing the coil device 100 may be reduced, or the coil device 100 may be downsized.

Next, the coil device 100 according to the present embodiment will be described in detail.

The coil device 100 refers to a device that has the coil 110. Examples of the coil device 100 include an antenna, an inductor, and a transformer. The coil device 100 may be electrically connected to another device or a component and may be a coil component which, together with other devices or components, constitutes an electronic circuit and is a component of an electrical device. Alternatively, the coil device 100 may have a closed electronic circuit and may function independently. The coil device 100 according to the present embodiment is an antenna device. Specifically, the coil device 100 according to the present embodiment is a radio-frequency identification tag (RF tag) that may be used to identify or detect commodities and the like. The RF tag according to the present embodiment which may be miniaturized may be attached to medical members such as gauze or medical instruments such as surgical instruments that are arranged or implanted in the body on a temporary or long-term basis. Alternatively, the coil device 100 may be used as a tuning coil or an LC filter to selectively extract or selectively pass signals in a specific frequency band.

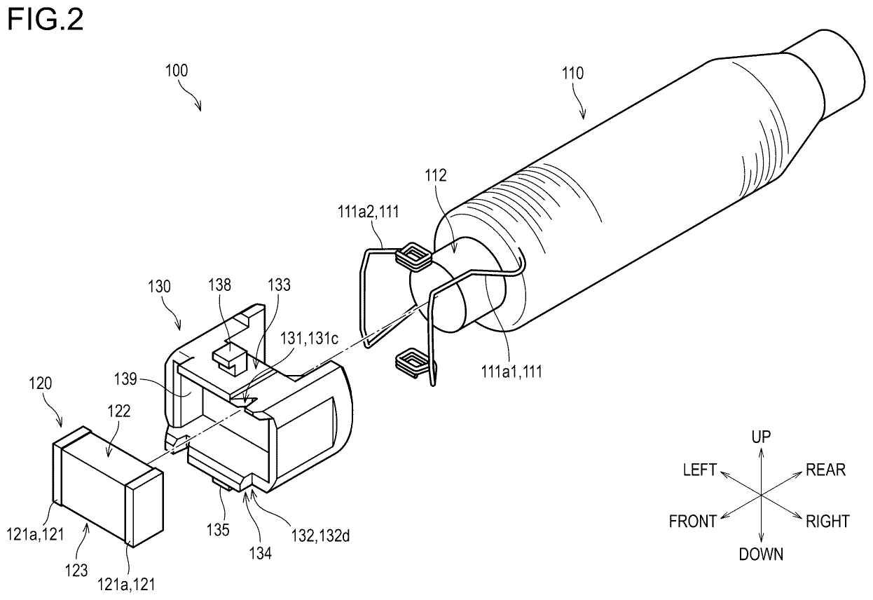

The coil wire 111 is wound around the coil 110 according to the present embodiment. The coil 110 according to the present embodiment has a winding core 112 and the coil wire 111 is wound around the winding core 112. Individual coil wires 111 in a winding portion of the coil 110 shown in FIG. 1 are not shown in the drawing. A similar description applies to FIGS. 2 to 7. A shape of the coil 110 is not limited to the shape shown in the drawings and includes various shapes capable of functioning as the coil 110. For example, the coil 110 may be an air core coil that does not use the winding core 112. Alternatively, the coil wire 111 annularly arranged on a flat surface may be the coil 110.

The coil wire 111 is a conductive linear member. A cross-sectional shape of the coil wire 111 may be a circular shape, a polygonal shape, or a flat shape such as an ellipsoid or a rectangle. The coil wire 111 according to the present embodiment is constituted of a conductive core wire coated with an insulator film. Examples of a material of the insulator film include resins such as polyurethane.

Both end portions (first extracted portion 111a1 or second extracted portion 111a2) of the coil wire 111 are extracted from the coil 110. Specifically, both end portions are extracted from the coil 110 to a side of the chip capacitor 120 (base portion 130). In the present embodiment, while both end portions of the coil wire 111 are connected to both electrodes of the chip capacitor 120, respectively, the connection of the coil wire 111 is not limited thereto. Only one end portion of the coil wire 111 may be connected to one electrode of the chip capacitor 120. The other end portion of the coil wire 111 may be directly or indirectly connected to a terminal of another member that constitutes an electronic circuit together with the coil device 100 or the like.

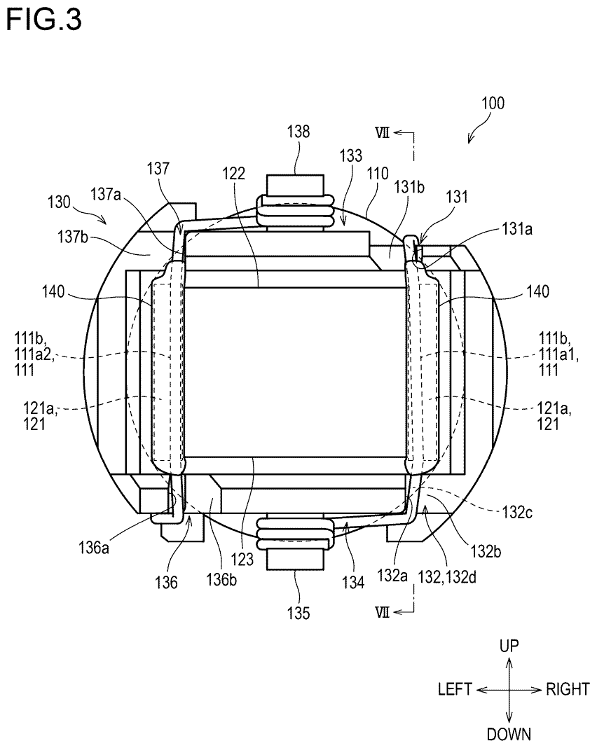

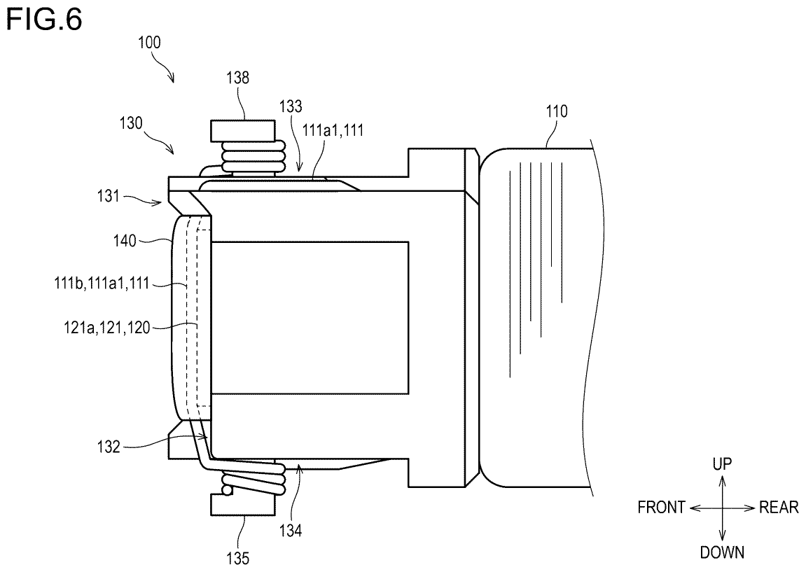

As described above, the connecting portion 111b is a partial length region of the coil wire 111 (in particular, the first extracted portion 111a1 or the second extracted portion 111a2). More specifically, as shown in FIG. 3 or 6, the connecting portion 111b is a partial length region (direct connection region) of the coil wire 111 which is in contact with the electrode surface 121a or immersed in the brazing material 140 to be described later. In addition, the connecting portion 111b may include a partial length region of a coil wire 111 which is directly adjacent to the connection region. In other words, the connecting portion 111b may be connected to the electrode surface 121a in its entirety or only a part of the connecting portion 111b may be connected to the electrode surface 121a.

The connecting portion 111b according to the present embodiment is a partial length region in the coil wire 111 that bridges between a first arrangement portion 131 and a second arrangement portion 132. In other words, the connecting portion 111b according to the present embodiment includes both the direct connection region which is arranged inside the brazing material 140 or in contact with the electrode surface 121a and the partial length region of the coil wire 111 which is exposed from the brazing material 140 at both ends of the direct connection region and which is separated from the electrode surface 121a.

The chip capacitor 120 is a capacitor of which a part of a surface of the electrode 121 is the planar electrode surface 121a. The chip capacitor 120 has the electrode 121 at both ends in the left-right direction. As shown in FIG. 2, while a shape of the chip capacitor 120 according to the present embodiment is an approximate rectangular parallelopiped, the shape of the chip capacitor 120 is not limited thereto.

Specifically, the electrode surface 121a is a planar region that connects to the connecting portion 111b in an outer surface of the electrode 121. The connecting portion 111b is arranged along the electrode surface 121a. The electrode surface 121a according to the present embodiment is a surface facing a direction (forward) in which the base portion 130 opens in the outer surface of the electrode 121.

Instead of the present embodiment, the connecting portion 111b may be connected to the electrode surface 121a with any region on the outer surface of the electrode 121 as the electrode surface 121a. For example, the connecting portion 111b may be connected by bringing the connecting portion 111b into contact with a part of the outer surface facing either the left or right direction in the electrode 121, in which case the electrode surface 121a is the part of the outer surface facing either the left or right direction in the electrode 121.

The connecting portion 111b and the electrode surface 121a being directly connected to each other means that the connecting portion 111b and the electrode surface 121a are connected to each other without the intervention of other conductive members such as metal wiring (excluding connecting agents such as the brazing material 140 to be described later for connecting the connecting portion 111b and the electrode surface 121a to each other). For example, the connecting portion 111b and the electrode surface 121a being directly connected to each other means that the connecting portion 111b and the electrode surface 121a are in direct contact with and electrically connected to each other. Alternatively, the connecting portion 111b and the electrode surface 121a being directly connected to each other means that the connecting portion 111b and the electrode surface 121a are connected by a connecting agent such as the brazing material 140 to be described later and electrically connected to each other via the connecting agent. The connecting agent is preferably constituted of a material that is flexible enough to be arranged on the connecting portion 111b or the electrode surface 121a by application or the like and subsequently solidifies when connecting the connecting portion 111b and the electrode surface 121a to each other. Examples of the connecting agent include brazing materials such as solder and conductive adhesives.

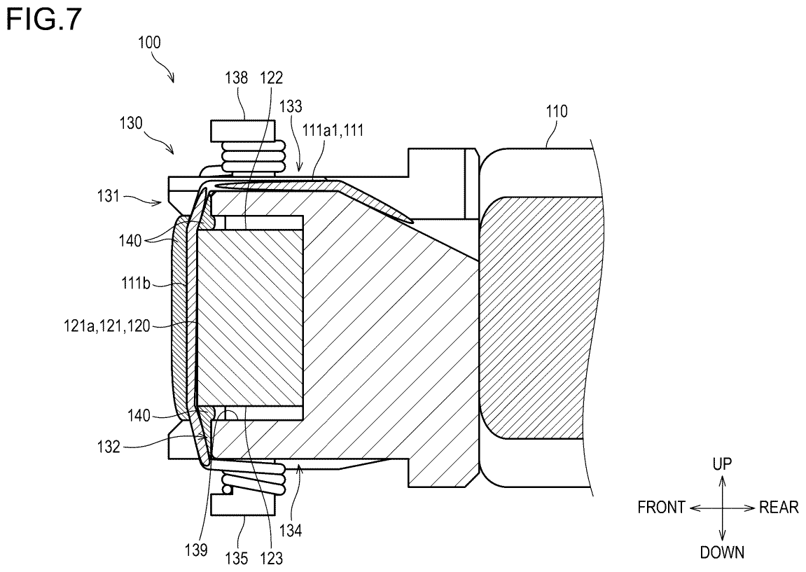

In the present embodiment, as shown in FIG. 7, the connecting portion 111b is arranged along the electrode surface 121a and is directly in contact with the electrode surface 121a. The connecting portion 111b may be in pressurized contact or simply in contact with the chip capacitor 120.

Furthermore, in the present embodiment, as shown in FIG. 6, the connecting portion 111b is bonded to the electrode surface 121a by the brazing material 140. The connecting portion 111b is immersed in the brazing material 140. In the present embodiment, as shown in FIG. 3 or 6, the brazing material 140 covers the front, left and right sides of the electrode 121. The brazing material 140 may or may not be arranged so as to penetrate between the chip capacitor 120 and the connecting portion 111b.

In addition, in the connecting portion 111b, the core wire is preferably exposed without being covered by an insulator film. In other words, preferably, the insulating film in the connecting portion 111b is removed by stripping or by dissolution, decomposition, or sublimation by immersion in the molten brazing material 140 in advance or during the process of connection.

As shown in FIG. 1 or 2, the coil device 100 further includes the base portion 130. The base portion 130 is preferably formed of an insulating material, and the base portion 130 according to the present embodiment is formed of a resin. The base portion 130 holds the chip capacitor 120. Preferably, the base portion 130 holds the chip capacitor 120 in the coil 110.

In the present embodiment, the chip capacitor 120 is held by the base portion 130 by having a part of the chip capacitor 120 housed in the base portion 130. A housing depression 139 that opens forward is formed in the base portion 130. At least a part of the chip capacitor 120 is housed inside the housing depression 139. As shown in FIG. 7, the chip capacitor 120 is arranged so that the chip capacitor 120 comes into contact with a bottom portion of the housing depression 139. The chip capacitor 120 and the bottom portion of the housing depression 139 may be in direct contact with each other or the chip capacitor 120 may be bonded to the base portion 130 by an adhesive (not shown in the drawing) applied to a surface of the bottom portion of the base portion 130.

In addition, as described below, the base portion 130 is fixed to the coil 110. As shown in FIG. 2, a notch into which the coil 110 (in particular, a front end portion of the winding core 112) is to be fitted is formed in a rear portion of the base portion 130. The notch for housing a coil is opened upward and rearward. The coil 110 (in particular, the winding core 112) is fixed to the base portion 130 by being fitted into the coil-housing notch of the base portion 130 from above downward or from the rear forward.

The base portion 130 is not limited to a shape having the housing depression 139 and may be any shape as long as the shape enables the chip capacitor 120 to be held. The base portion 130 may be a member having a side portion or a bottom portion that covers a part of the chip capacitor 120 without the housing depression 139 or a member having a structure (such as an engagement structure) that couples the base portion 130 and the chip capacitor 120 to each other without having the side portion or even the bottom portion. Alternatively, instead of the present embodiment, the coil device 100 need not have the base portion 130. For example, the coil 110 and the chip capacitor 120 may be held in a desired positional relationship by being stored in a case for storing the coil 110 and the chip capacitor 120 to be described later.

In order to reduce overall sizes of the chip capacitor 120 and the coil 110, the coil device 100 according to the present embodiment is configured as follows.

As shown in FIG. 6, the base portion 130 and the coil 110 (in particular, the winding portion) are in contact with each other. Accordingly, a dimension of the coil device 100 in a winding axis direction may be reduced. Instead of the present embodiment, the base portion 130 and the coil 110 may be separated from each other in the winding axis direction.

In addition, as shown in FIG. 3, the chip capacitor 120 used is preferably sufficiently small with respect to the coil 110. Specifically, preferably, an outer shape of the chip capacitor 120 is largest when viewed in the winding axis direction, but the largest outer shape of the chip capacitor 120 (outer shape when viewed in the winding axis direction) is smaller than an outer shape of the coil 110 when viewed in the winding axis direction. In addition, the chip capacitor 120 is preferably arranged so that the outer shape of the chip capacitor 120 fits into the outer shape of the coil 110 when viewed in the winding axis direction. Instead of the present embodiment, the coil 110 of which the outer shape in the winding axis direction is smaller than the largest outer shape of the chip capacitor 120 may be used. Downsizing of the coil device 100 may be achieved by using such a small coil. In addition, a part of the chip capacitor 120 and the coil 110 need not overlap with each other when viewed in the winding axis direction.

Furthermore, the chip capacitor 120 is arranged with respect to the coil 110 in an orientation that minimizes the dimension of the chip capacitor 120 in the winding axis direction. More specifically, the dimension of the chip capacitor 120 in the winding axis direction according to the present embodiment is larger than the dimension of the chip capacitor 120 in each of a width direction and a thickness direction of the coil device 100. Accordingly, the dimension of the coil device 100 in the winding axis direction may be kept small and downsizing may be achieved.

As shown in FIGS. 1 and 2, the base portion 130 has a first side portion 133 and a second side portion 134. The first side portion 133 covers a partial region (first covered surface 122) of the surface of the chip capacitor 120. The second side portion 134 covers another partial region (second covered surface 123) of the surface of the chip capacitor 120. In other words, the first side portion 133 and the second side portion 134 are arranged along each of the first covered surface 122 and the second covered surface 123 so as to cover a part of the chip capacitor 120.

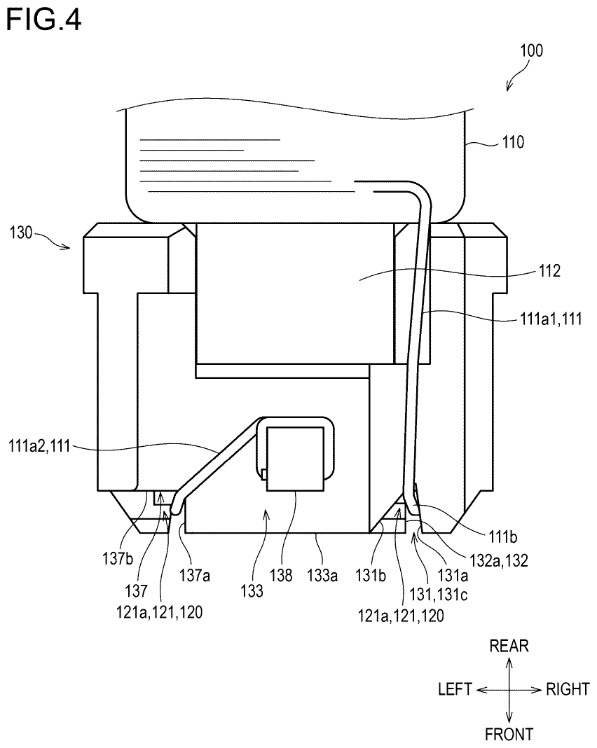

In the present embodiment, the first side portion 133 is a side wall which demarcates the housing depression 139 and which is arranged above the chip capacitor 120. The first side portion 133 covers approximately the entire surface (first covered surface 122) which faces upward in the outer surface of the chip capacitor 120. In this case, the first side portion 133 covering approximately the entire first covered surface 122 includes the chip capacitor 120 (electrode surface 121a and the like) being slightly exposed from the first side portion 133 in a notched portion 131c or a second turning portion 137 as shown in FIG. 4 and described later.

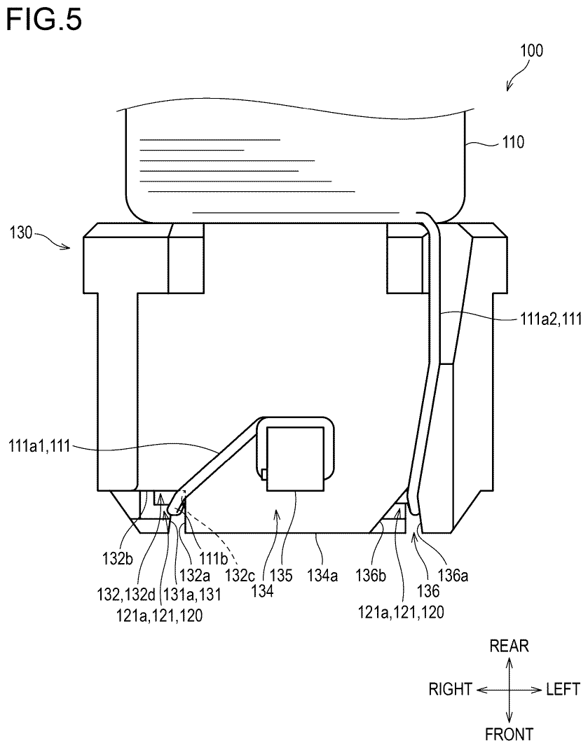

The second side portion 134 is a side wall which demarcates the housing depression 139 and which is arranged below the chip capacitor 120. The second side portion 134 covers approximately the entire surface (second covered surface 123) which faces downward in the outer surface of the chip capacitor 120. In this case, the second side portion 134 covering approximately the entire second covered surface 123 includes the surface of the chip capacitor 120 being slightly exposed from the second side portion 134 in a turning portion 132 or a second notched portion 136 as shown in FIG. 5 and described later.

Instead of the present embodiment, the first side portion 133 or the second side portion 134 may only cover a part of the surface facing upward or downward of the chip capacitor 120.

In the present embodiment, the first side portion 133 and the second side portion 134 face each other at 180 degrees across the chip capacitor 120. Instead of the present embodiment, the first side portion 133 and the second side portion 134 may be arranged in another positional relationship across the chip capacitor 120. For example, among four side walls which demarcate the housing depression 139 formed in a rectangle, each of two adjacent side walls may be adopted as the first side portion 133 and the second side portion 134. In this case, a part of the first side portion 133 and a part of the second side portion 134 diagonally face each other and the chip capacitor 120 is arranged between the respective parts.

As shown in FIG. 3, the chip capacitor 120 and the side wall of the housing depression 139 are separated from each other. In particular, the first covered surface 122 and the first side portion 133 are separated from each other and the second covered surface 123 and the second side portion 134 are separated from each other.

As shown in FIG. 3, the connecting portion 111b of the coil wire 111 bridges between the first arrangement portion 131 and the second arrangement portion 132. Specifically, in the present embodiment, a part on an extraction source side (hereinafter, also referred to as a base end side) of the coil wire 111 in the connecting portion 111b is arranged in the first arrangement portion 131 and a part on a side of a coil wire distal end in the connecting portion 111b is arranged in the second arrangement portion 132.

The first arrangement portion 131 and the second arrangement portion 132 are formed in the first side portion 133 or the second side portion 134, respectively. In other words, the first arrangement portion 131 is formed in the first side portion 133 and the second arrangement portion 132 is formed in the second side portion 134. The first arrangement portion 131 and the second arrangement portion 132 are arranged across a part of the chip capacitor 120 (in particular, the electrode surface 121a of the electrode 121). Due to the connecting portion 111b being arranged so as to bridge between parts of the base portion 130 which are arranged across the chip capacitor 120 in this manner, the connecting portion 111b is arranged at a position where the connecting portion 111b and the chip capacitor 120 (electrode surface 121a) may be readily connected to each other.

In this case, the first arrangement portion 131 and the second arrangement portion 132 being arranged across a part of the chip capacitor 120 means that the chip capacitor 120 (in particular, the electrode surface 121a of the electrode 121) is arranged on a straight line connecting a part of the first arrangement portion 131 and a part of the second arrangement portion 132. In other words, when viewed from an extension direction of the connecting portion 111b (approximately up-down direction), the connecting portion 111b overlaps with each of the first arrangement portion 131 (in particular, the notched portion 131c to be described later) and the second arrangement portion 132 (in particular, a wire arrangement depression 132d to be described later).

As will be described below, the first arrangement portion 131 and the second arrangement portion 132 according to the present embodiment are depressions provided in the base portion 130 and formed so as to arrange the coil wire 111. Furthermore, shapes of the first arrangement portion 131 and the second arrangement portion 132 according to the present embodiment differ from each other. Specifically, both the first arrangement portion 131 and the second arrangement portion 132 have opening portions, and comparing the manners in which the respective opening portions of the first arrangement portion 131 and the second arrangement portion 132 are opened, the shape of the opening portion of the second arrangement portion 132 is more open than that of the opening portion of the first arrangement portion 131.

First, as shown in FIG. 4, the first arrangement portion 131 is a part of the base portion 130. The first arrangement portion 131 according to the present embodiment is a notch forming portion 131 which demarcates the notched portion 131c through which the coil wire 111 passes. In this case, the notch forming portion 131 refers to a surface of a wall portion to be described later which forms the notched portion 131c and a part of a vicinity of the surface. Specifically, in the present embodiment, the notched portion 131c is formed by notching an end surface (first end surface 133a) of the first side portion 133. More specifically, the notched portion 131c according to the present embodiment has a V-shape.

The notched portion 131c is demarcated by a pair of wall portions (upright portion 131a and inclined surface portion 131b to be described later). An angle formed between the pair of wall portions is less than 180 degrees. Preferably, the angle is an acute angle of less than 90 degrees and more preferably less than 60 degrees. The angle is preferably equal to or more than 30 degrees and more preferably equal to or more than 45 degrees.

In addition, in the present embodiment, a bottom portion is provided between the upright portion 131a and the inclined surface portion 131b and the notched portion 131c is demarcated by the upright portion 131a, the inclined surface portion 131b, and the bottom portion. A width of the bottom portion is greater than a diameter of the coil wire 111. Alternatively, the width of the bottom portion may be smaller than or approximately equivalent to the diameter of the coil wire 111. In addition, instead of the present embodiment, a bottom portion may not be provided between the upright portion 131a and the inclined surface portion 131b, the upright portion 131a and the inclined surface portion 131b may be arranged adjacent to each other, and the notched portion 131c may be formed by the upright portion 131a and the inclined surface portion 131b.

Instead of the present embodiment, the first arrangement portion 131 may be an end portion of the first side portion 133 including an end surface of the first side portion 133. In other words, the notched portion 131c may not be formed in the first arrangement portion 131 and the coil wire 111 may be in contact or pressurized contact with the end surface of the first side portion 133. In this case, the first arrangement portion 131 is the end surface of the first side portion 133 which the coil wire 111 comes into contact or pressurized contact with and a part of a vicinity of the end surface. Alternatively, the first arrangement portion 131 may be a depression which is demarcated by being sandwiched between a pair of protruding portions that protrude from the base portion 130. The depression and the protruding portions which demarcate the depression may have features similar to those of the notched portion 131c and the wall portion of the notched portion 131c to be described later.

Next, a shape of the second arrangement portion 132 will be described. As shown in FIG. 5, the second arrangement portion 132 according to the present embodiment is the turning portion 132 at which the coil wire 111 comes into contact with and bends. At the turning portion 132, the coil wire 111 may be curved in an arc shape or folded and bent so that an angle is created. The coil wire 111 may be in pressurized contact or simply in contact with the turning portion 132. The coil wire 111 bends while in contact with the turning portion 132 from the connecting portion 111b to a distal end and turns toward a fixing portion 135 to be described later.

In the present embodiment, the turning portion 132 is the wire arrangement depression 132d formed by notching the end surface (second end surface 134a) of the second side portion 134 in an approximately rectangular shape. More specifically, the second side portion 134 is notched in an L-shape to form the wire arrangement depression 132d. A part of the wire arrangement depression 132d is demarcated by a turning wall portion 132a and a turning bottom portion 132b to be described later. Specifically, the turning wall portion 132a that constitutes the turning portion 132 is arranged in the winding axis direction and the turning bottom portion 132b that constitutes the turning portion 132 is arranged in a direction (left-right direction) orthogonal to the winding axis direction. In addition, the wire arrangement depression 132d is formed opened forward and rightward.

The turning portion 132 may be divided into two portions (surfaces) across a contact portion 132c. In other words, as described above, the turning portion 132 is constructed so as to include the turning wall portion 132a and the turning bottom portion 132b and the contact portion 132c is sandwiched between the turning wall portion 132a and the turning bottom portion 132b. In this case, the turning wall portion 132a and the turning bottom portion 132b indicate wall surfaces that demarcate the wire arrangement depression 132d, and the turning portion 132 indicates a wall surface such as the turning wall portion 132a and the turning bottom portion 132b and a part of the base portion 130 in a vicinity of the wall surface. The contact portion 132c is a part of the turning portion 132 which the coil wire 111 is in contact with. In the present embodiment, a corner portion of the rectangular wire arrangement depression 132d is the contact portion 132c.

As will be described later, a part and another part (turning wall portion 132a and turning bottom portion 132b) of the turning portion 132 across the contact portion 132c form a predetermined angle around the contact portion 132c. While the angle is approximately 90 degrees in the present embodiment, the angle is not limited thereto. The angle is preferably equal to or more than 90 degrees. In addition, the angle is preferably equal to or less than 180 degrees. The angle may be less than 90 degrees.

Instead of the present embodiment, the second side portion 134 may not be notched and the turning portion 132 may simply be an end surface of the base portion 130 (second side portion 134) where the coil wire 111 comes into contact with and turns. In other words, an angle formed around the contact portion 132c by a part and other part of the turning portion 132 across the contact portion 132c may be 180 degrees. For example, the second side portion 134 may have an end surface facing forward or rightward and the coil wire 111 may be in contact with the end surface.

As described above, the first arrangement portion 131 has an opening portion with a closed shape and the second arrangement portion 132 has an opening portion with an open shape. Specifically, an angle formed by the turning portion 132 around the contact portion 132c in the turning portion 132 is greater than an angle formed by the pair of wall portions (upright portion 131a and inclined surface portion 131b) which demarcate the notched portion 131c. The angle formed by the turning portion 132 around the contact portion 132c in the turning portion 132 refers to an angle formed around the contact portion 132c by a part and another part of the turning portion 132 across the contact portion 132c and, specifically, is an angle formed between the turning wall portion 132a and the turning bottom portion 132b. The angle formed by the pair of wall portions that demarcate the notched portion 131c is the angle formed between the upright portion 131a and the inclined surface portion 131b as described above.

In this manner, due to the first arrangement portion 131 in which a part of the coil wire 111 on a base end side is arranged having an opening portion with a closed shape and the second arrangement portion 132 in which a part of the coil wire 111 on a distal end side is arranged having an opening portion with an open shape, the coil device 100 may be readily manufactured. In other words, when fixing the coil wire 111 extracted from the coil 110 to the base portion 130 in a manufacturing process to be described later, routing of the coil wire 111 may be performed in an efficient manner. More specifically, locations of the coil wire 111 to be routed may be fixed when arranging the coil wire 111 in the first arrangement portion 131. In addition, when arranging the coil wire 111 in the turning portion 132, since the turning portion 132 has an open shape, routing errors such as the coil wire 111 not being arranged inside the wire arrangement depression 132d may be avoided.

As shown in FIG. 4, in the present embodiment, the notch forming portion 131 has an asymmetrical shape. As described above, the notched portion 131c is demarcated by a pair of wall portions (upright portion 131a and inclined surface portion 131b). An angle formed by one wall portion (upright portion 131a) with respect to the first end surface 133a is greater than an angle formed by the other wall portion (inclined surface portion 131b) with respect to the first end surface 133a. In other words, the upright portion 131a is arranged to rise more steeply with respect to the first end surface 133a and the inclined surface portion 131b is arranged to lie more flatly with respect to the first end surface 133a.

In this case, an angle formed by the respective wall portions that form the notched portion 131c with respect to the first end surface 133a refers to a smaller angle among angles formed between the first end surface 133a and the respective wall portions. The first end surface 133a is an end surface on which the notched portion 131c in the first side portion 133 is provided. More specifically, the first end surface 133a is a surface in the end portion of the first side portion 133 including the end surface of the first side portion 133 in a hypothetical case where the notched portion 131c is not formed. The first end surface 133a may be a flat surface as in the present embodiment, a curved surface, or a narrow surface substantially constituted of a line. An extension direction of the first end surface 133a according to the present embodiment is the left-right direction.

When viewed in the extension direction of the connecting portion 111b (approximately up-down direction according to the present embodiment), the upright portion 131a and the turning portion 132 (turning wall portion 132a) are arranged across the connecting portion 111b. Accordingly, both ends of the connecting portion 111b may be brought into pressurized contact with the base portion 130 in mutually different orientations (in the present embodiment, respective orientations in the left-right direction). Therefore, the routing of the coil wire 111 stabilizes such as the coil wire 111 routed to the base portion 130 becoming less likely to detach from the base portion 130.

Specifically, as shown in FIG. 4 in which the coil device 100 is viewed from above or in FIG. 5 in which the coil device 100 is viewed from below, the upright portion 131a and the turning wall portion 132a face each other across the connecting portion 111b. In other words, when viewed in a separation direction of the first arrangement portion 131 and the second arrangement portion 132 (approximately up-down direction), the upright portion 131a and the turning wall portion 132a are separated from and face each other across a separating gap. In this case, the upright portion 131a and the turning wall portion 132a facing each other need only require that the upright portion 131a and the turning wall portion 132a have a common direction component and is not limited to the upright portion 131a and the turning wall portion 132a being approximately parallel.

In addition, in the present embodiment, the coil wire 111 at each of both ends of the connecting portion 111b is arranged towards a different direction in the left-right direction. Specifically, as shown in FIG. 4, the coil wire 111 on the base end side of the connecting portion 111b is arranged rearward and rightward. In other words, when viewed in the extension direction of the connecting portion 111b (for example, when viewed from above), an extension direction of the coil wire 111 on the base end side of the connecting portion 111b has a component in a direction from the connecting portion 111b toward the upright portion 131a. On the other hand, as shown in FIG. 5, the coil wire 111 on the distal end side of the connecting portion 111b is arranged rearward and leftward. In other words, when viewed in the extension direction of the connecting portion 111b (for example, when viewed from below), an extension direction of the coil wire 111 on the distal end side of the connecting portion 111b has a component in a direction from the connecting portion 111b toward the turning wall portion 132a.

In the present embodiment, the coil wire 111 is not in contact with the upright portion 131a and is separated from the upright portion 131a but the coil wire 111 is in contact with the turning wall portion 132a. The coil wire 111 (connecting portion 111b) may be in contact (contact or pressurized contact) with each of the upright portion 131a and the turning wall portion 132a or may be separated instead of being in contact with each of the upright portion 131a and the turning wall portion 132a.

When viewed facing the first covered surface 122 or the second covered surface 123, a part of the electrode surface 121a is exposed from an end portion including the first arrangement portion 131 or the second arrangement portion 132 in the base portion 130. In other words, a part of the chip capacitor 120 (a part including the electrode surface 121a) protrudes in an opening direction (facing forward) of the housing depression 139 more than at least a part of the first side portion 133 or the second side portion 134, and the electrode surface 121a is arranged outside in the opening direction more than a part of an end portion of the first side portion 133 or the second side portion 134. Outside in the opening direction refers to a direction from a center inside the coil device 100 toward outside in the opening direction. Accordingly, the connecting portion 111b may be readily arranged so as to come into contact with the electrode surface 121a.

In the present embodiment, as shown in FIG. 4, when viewed facing the first covered surface 122 (in an upward view), a part of the electrode surface 121a is exposed from the notched portion 131c. In other words, the electrode surface 121a is arranged outward in the opening direction of the housing depression 139 than the bottom portion of the notch forming portion 131. In addition, as shown in FIG. 5, when viewed facing the second covered surface 123 (in a downward view), a part of the electrode surface 121a is exposed from the wire arrangement depression 132d. In other words, the electrode surface 121a is arranged outward in the opening direction of the housing depression 139 than the turning bottom portion 132b of the wire arrangement depression 132d.

Note that the electrode surface 121a being exposed from the base portion 130 only requires the electrode surface 121a arranged outside in a predetermined direction (in the present embodiment, a forward orientation that is the opening direction of the housing depression 139) than the end portion of the base portion 130 and is not limited to approximately the entirety of the electrode surface 121a or a partial planar region thereof being visible in an upward view or a downward view. For example, the electrode surface 121a being exposed from the base portion 130 includes viewing the electrode surface 121a, which virtually has no thickness as in the present embodiment, in a direction orthogonal to the thickness direction of the electrode surface 121a. In this case, the partial planar region of the electrode surface 121a need not be visible. Furthermore, the electrode surface 121a being exposed from the end portion of the base portion 130 is preferably confirmable according to a positional relationship between the base portion 130 and the electrode surface 121a. In other words, the electrode surface 121a exposed from the end portion of the base portion 130 need not be confirmable due to members other than the base portion 130 and the electrode surface 121a. For example, the electrode surface 121a exposed from the end portion of the base portion 130 may be hidden by other members such as the large-diameter coil wire 111 in an upward view or a downward view and the exposed electrode surface 121a may not be visually confirmable.

In addition, as shown in FIGS. 4 and 5 in the present embodiment, the chip capacitor 120 (in particular, the electrode surface 121a) does not protrude further forward than the first end surface 133a or the second end surface 134a. In other words, a depth of the housing depression 139 (a depth from the first end surface 133a or the second end surface 134a to the housing depression 139) is greater than a dimension of the chip capacitor 120 in a depth direction of the housing depression 139. Instead of the present embodiment, the chip capacitor 120 may protrude further forward than the first end surface 133a or the second end surface 134a. In other words, when viewed from above or below, the chip capacitor 120 may protrude from the first end surface 133a or the second end surface 134a.

As described above, as shown in FIGS. 3 and 7, the electrode surface 121a of the chip capacitor 120 and the connecting portion 111b are brazed together by the brazing material 140 in the present embodiment. Examples of the brazing material 140 include solder.

As shown in FIGS. 3, 6, and 7, in the present embodiment, the brazing material 140 is arranged so as to cover a forward side of the electrode 121 (electrode surface 121a) or to cover a part of a surface facing the left-right direction (a part of the forward side) of the electrode 121. In other words, in the present embodiment, approximately an entire surface of the electrode 121 exposed from the base portion 130 is covered and protected by the brazing material 140. In addition, due to the brazing material 140 being arranged across a plurality of surfaces facing different directions in the electrode 121 in this manner, the brazing material 140 is firmly adhered to the chip capacitor 120.

As shown in FIG. 7, a part of the brazing material 140 is preferably arranged between the coil wire 111 and the first arrangement portion 131 or the second arrangement portion 132. More preferably, as in the present embodiment, a part of the brazing material 140 is arranged between the coil wire 111 and each of the first arrangement portion 131 and the second arrangement portion 132. Specifically, a part of the brazing material 140 is arranged in a gap between the coil wire 111 arranged in the first arrangement portion 131 and the first arrangement portion 131 (in particular, the bottom portion, the upright portion 131a, or the inclined surface portion 131b which forms the notched portion 131c). Alternatively, a part of the brazing material 140 is arranged in a gap between the coil wire 111 arranged in the second arrangement portion 132 and the second arrangement portion 132 (in particular, the turning wall portion 132a or the turning bottom portion 132b). Due to the brazing material 140 being not only arranged in the periphery of the electrode surface 121a but also arranged so as to penetrate into the gap between the coil wire 111 and the first arrangement portion 131 or the second arrangement portion 132, the brazing material 140 is prevented from peeling off and detaching from the electrode 121 or the connecting portion 111b.

In the present embodiment, the brazing material 140 is disposed inside the notched portion 131c. The brazing material 140 is arranged between the coil wire 111 that passes through the notched portion 131c and a part of the base portion 130 (the notch forming portion 131) that defines the notched portion 131c. Similarly, in the present embodiment, the brazing material 140 is disposed in a space defined in the turning portion 132. The brazing material 140 is arranged between the coil wire 111 that passes through the space defined in the turning portion 132 and a part of the base portion 130 that defines the turning portion 132.

In the present embodiment, as illustrated in FIG. 7, a portion of the brazing material 140 may be disposed so as to enter between the chip capacitor 120 and the base portion 130. Specifically, a portion of the brazing material 140 may be interposed between the chip capacitor 120 (the first covered surface 122) and the first side portion 133. Alternatively or additionally, a portion of the brazing material 140 may be interposed between the chip capacitor 120 (the second covered surface 123) and the second side portion 134.

While the coil wire 111 arranged in the first arrangement portion 131 or the second arrangement portion 132 and the brazing material 140 are in contact with each other in the present embodiment, the coil wire 111 and the brazing material 140 may be separated from each other. In addition, while the brazing material 140 and each of the first arrangement portion 131 and the second arrangement portion 132 are in contact with each other in the present embodiment, the brazing material 140 and each of the first arrangement portion 131 and the second arrangement portion 132 may be separated from each other.

Furthermore, instead of the present embodiment, a gap portion may be provided between the coil wire 111 and each of the first arrangement portion 131 and the second arrangement portion 132 and the brazing material 140 need not be arranged. In addition, an adhesive other than the brazing material 140 may be arranged as described above. Furthermore, instead of the present embodiment, the connecting portion 111b and the electrode surface 121a may not be bonded by brazing or the like and the connecting portion 111b and the electrode surface 121a may be electrically connected to each other by simply coming into contact with each other.

As shown in FIG. 1, the chip capacitor 120 is arranged on one side (forward side) of the coil 110 in the winding axis direction of the coil 110 (front-rear direction). In addition, the second covered surface 123 which is covered by the second side portion 134 extends in the winding axis direction and the width direction of the coil device 100 (left-right direction).

As shown in FIG. 3, the second side portion 134 has the fixing portion 135 to which the distal end of the coil wire 111 is fixed. The fixing portion 135 according to the present embodiment is a connection portion to which the distal end of the coil wire 111 is connected and fixed. More specifically, the fixing portion 135 is formed so as to protrude upward from the surface (upper surface) of the base portion 130. As shown in FIG. 6, a protruding end portion of the fixing portion 135 has a flange that is formed thicker than a base end portion of the fixing portion 135 (a part to which the coil wire 111 is connected).

As shown in FIG. 3, at least a part of the fixing portion 135 when viewed in the winding axis direction is formed more centrally than the second arrangement portion 132 in the width direction of the coil device 100 in the second side portion 134. Preferably, the fixing portion 135 when viewed in the winding axis direction is formed approximately at center in the width direction of the coil device 100 in the second side portion 134.

The shape of the coil 110 when viewed in the winding axis direction in the present embodiment is approximately circular and an outline of the coil 110 when viewed in the winding axis direction is bulkiest at approximately the center of the coil device 100 in the width direction (left-right direction). In other words, the dimension of the coil 110 when viewed in the winding axis direction (dimension in the up-down direction) is largest in the width direction. On the other hand, the fixing portion 135 that is formed so as to protrude from a part of the base portion 130 requires a predetermined space. Arranging the fixing portion 135 at center instead of at the end in the width direction of the coil device 100 prevents the outer shape of the base portion when viewed in the winding axis direction from significantly deviating from the outer shape of the coil 110. Accordingly, an envelope volume of the coil device 100 may be kept small and the coil device 100 may be downsized.

Note that when the second side portion 134 extends in the winding axis direction (front-rear direction) and the thickness direction of the coil device 100 (up-down direction), the fixing portion 135 is preferably formed more centrally than the second arrangement portion 132 in the up-down direction in the second side portion 134. In this case, the up-down direction may be considered the width direction of the coil device 100.

Instead of the present embodiment, the fixing portion 135 may be a part of the base portion 130 to which an end portion of the coil wire 111 is simply fixed by bonding, welding, brazing, or another connection method.

In the present embodiment, the second extracted portion 111a2 is also fixed to the base portion 130 and directly connected to the electrode surface 121a in a similar manner to the first extracted portion 111a1. Specifically, the partial length region (connecting portion 111b) in the second extracted portion 111a2 is brazed and bonded to the electrode surface 121a by the brazing material 140. The connecting portion 111b bridges between the second notched portion 136 and the second turning portion 137 provided in the base portion 130. The second notched portion 136 is a notch formed in the second side portion 134 and has a similar shape to the notch forming portion 131. The second turning portion 137 is a depression formed in the first side portion 133 and has a similar shape to the turning portion 132. A distal end of the second extracted portion 111a2 is connected and fixed to a second fixing portion 138 formed in the first side portion 133. The second fixing portion 138 is formed in a similar shape to the fixing portion 135.

The coil device 100 may have a case (not shown) which may house the coil 110, the base portion 130, and the chip capacitor 120. The case according to the present embodiment has a cylindrical shape that is elongated in the winding axis direction.

### (Chip Capacitor Holder)

The base portion 130 may be provided separately from the chip capacitor 120 or the coil 110 as a holder for holding the chip capacitor 120.

The chip capacitor holder (base portion 130) has a mounting portion (housing depression 139) for mounting a chip capacitor, the first side portion 133, and the second side portion 134. The first side portion 133 and the second side portion 134 are separated from and face each other across the mounting portion.

The notched portion 131c is formed on the end surface of the first side portion 133. Another notched portion (wire arrangement depression 132d) is formed on the end surface of the second side portion 134. The notched portion 131c and the wire arrangement depression 132d overlap with each other when viewed in a separation direction of the first side portion 133 and the second side portion 134 (up-down direction). At least a part of the notched portion 131c and at least a part of the wire arrangement depression 132d may overlap with each other when viewed in the separation direction. According to such a holder, the chip capacitor 120 may be held and the coil wire 111 may be suitably arranged.

### (Method of Manufacturing Coil Device)

Hereinafter, a method of manufacturing the coil device 100 according to the present embodiment (hereinafter, may be referred to as “present method”) will be described.

First, an overview of the present method will be described.

As described above, the coil device 100 that is manufactured by the present method includes: the coil 110 around which the coil wire 111 is wound; a chip capacitor 120 which electrically connects to the coil 110 and which has the electrode surface 121a; and the base portion 130 which holds the chip capacitor 120.

In the present method, the coil wire 111 is extracted from the coil 110 and the connecting portion 111b is directly connected to the electrode surface 121a. Due to the coil wire 111 and the electrode surface 121a being directly connected to each other, the coil device 100 may be readily manufactured, the cost of manufacturing the coil device 100 may be reduced, or the coil device 100 may be downsized.

More specifically, the connecting portion 111b is arranged so as to bridge between the first arrangement portion and the second arrangement portion. As described above, the first arrangement portion 131 and the turning portion 132 are parts of the base portion 130 and are arranged across a part of the electrode surface. The connecting portion 111b is arranged so as to come into pressurized contact with the electrode surface 121a and, in this arranged state, the connecting portion 111b is connected to the electrode surface 121a. Bringing the connecting portion 111b into pressurized contact with the electrode surface 121a enables the connecting portion 111b and the electrode surface 121a to be readily connected to each other.

Next, the present method will be described in detail.

First, the coil wire 111 (first extracted portion 111a1) extracted from the coil 110 is routed as follows. When routing the coil wire 111, preferably, a certain amount of tension is applied while routing so that the routed coil wire 111 does not sag.

As shown in FIG. 4, the first extracted portion 111a1 is extracted forward from the winding portion of the coil wire 111 along a surface of the first side portion 133. More specifically, the first extracted portion 111a1 is extracted forward and leftward from the winding portion of the coil 110. In other words, as described above, an extension direction of a part of the first extracted portion 111a1 arranged along the surface of the first side portion 133 includes a left-right direction component in addition to a winding axis direction (front-rear direction) component.

The first extracted portion 111a1 having been extracted up to the first arrangement portion 131 that is the notch forming portion 131 turns starting from the first arrangement portion 131. Specifically, as shown in FIG. 3, the first extracted portion 111a1 bends so as to pass through the interior of the notched portion 131c and is extracted downward toward the second arrangement portion 132. When the first extracted portion 111a1 turns at the first arrangement portion 131, the first extracted portion 111a1 may come into pressurized contact with the first arrangement portion 131 (in particular, the upright portion 131a or the inclined surface portion 131b). As shown in FIG. 7, the first extracted portion 111a1 bends twice in a process of being extracted from the first arrangement portion 131 to the second arrangement portion 132 by coming into contact with each of two corners of the chip capacitor 120.

The first extracted portion 111a1 having been extracted up to the second arrangement portion 132 that is the turning portion 132 turns starting from the turning portion 132. Specifically, as shown in FIG. 5, the first extracted portion 111a1 passes through the wire arrangement depression 132d and is extracted toward the fixing portion 135. Accordingly, the first extracted portion 111a1 (connecting portion 111b (refer to FIG. 6 or 7)) that bridges between the first arrangement portion 131 (refer to FIG. 6 or 7) and the second arrangement portion 132 comes into pressurized contact with the electrode surface 121a of the chip capacitor 120. In addition, when the first extracted portion 111a1 turns in the turning portion 132, the first extracted portion 111a1 may come into pressurized contact with the turning portion 132.

As described above, the first extracted portion 111a1 is extracted toward the fixing portion 135. In the present embodiment, the first extracted portion 111a1 is extracted rearward and leftward along a surface of the second side portion 134. In other words, a part of the first extracted portion 111a1 along the surface of the second side portion 134 has a front-rear direction component and a left-right direction component. The first extracted portion 111a1 extracted up to the fixing portion 135 is connected and fixed to the fixing portion 135.

Instead of the present embodiment, the coil wire 111 may be routed in a procedure opposite to the procedure described above. In other words, the coil wire 111 may be fixed to the fixing portion 135, the coil wire 111 may be routed in the base portion 130, and the coil wire 111 may be subsequently wound round the winding core 112.

The second extracted portion 111a2 may be routed in a similar manner to the first extracted portion 111a1. Specifically, as shown in FIG. 5, the second extracted portion 111a2 is extracted forward toward the second notched portion 136 and turns upward at the second notched portion 136. In addition, as shown in FIG. 3, the second extracted portion 111a2 is extracted toward the second turning portion 137 while in contact with the electrode surface of the chip capacitor 120. The second extracted portion 111a2 turns at the second turning portion 137 and is fixed to the second fixing portion 138.

The second notched portion 136 is formed by the second upright portion 136a and the second inclined surface portion 136b, similar to the first notched portion 131. Furthermore, the second turning portion 137 is formed by the second turning wall portion 137a and the second turning bottom portion 137b, similar to the first turning portion 132.

Next, the connecting portion 111b of the coil wire 111 is connected to the electrode surface 121a. In the present embodiment, the coil wire 111 and the connecting portion 111b are bonded by the brazing material 140. In the present embodiment, as shown in FIG. 3, the brazing material 140 is not only arranged on a forward side of the electrode surface 121a but also arranged outside in the left-right direction of the chip capacitor 120 (electrode 121) as shown in FIG. 6. In addition, as shown in FIG. 7, at least a part of the connecting portion 111b is embedded in the brazing material 140. As described above, a part of the brazing material 140 is arranged in a gap between the coil wire 111 and each of the first arrangement portion 131 and the turning portion 132. In addition, in the present embodiment, a part of the brazing material 140 is arranged so as to penetrate into a gap between the first side portion 133 and the first covered surface 122 and a gap between the second side portion 134 and the second covered surface 123. Instead of the present embodiment, the brazing material 140 may only be arranged on the surface of the electrode surface 121a.

Brazing may be performed by immersing parts of the connecting portion 111b and the chip capacitor 120 in a tank containing the molten brazing material 140 such as a solder bath. In addition, brazing may be performed by arranging the molten brazing material 140 in the chip capacitor 120 and the connecting portion 111b. Otherwise, brazing may be performed by piling the brazing material 140 on the surface of the electrode surface 121a in advance to be solidified, and after arranging the coil wire 111 so as to come into pressurized contact with the brazing material 140, melting the brazing material 140.

After brazing, the coil wire 111 may be in pressurized contact or simply in contact with the chip capacitor (in particular, a corner or the electrode surface 121a) or the base portion 130 (in particular, the first arrangement portion 131 or the second arrangement portion 132).

Instead of the present embodiment, the connecting portion 111b and the electrode surface 121a may be electrically connected to each other by methods other than brazing. Specifically, the connecting portion 111b and the electrode surface 121a may be connected using a connecting agent other than the brazing material 140. Alternatively, the connecting portion 111b may be welded to the electrode surface 121a. Otherwise, the connecting portion 111b and the electrode surface 121a may be made to engage with each other by forming a depression on the electrode surface 121a and fitting the connecting portion 111b into the depression or the like. Alternatively, the connecting portion 111b may be brought into pressurized contact with and fixed to the electrode surface 121a and the connecting portion 111b and the electrode surface 121a may be connected due to the contact.

### Second Embodiment

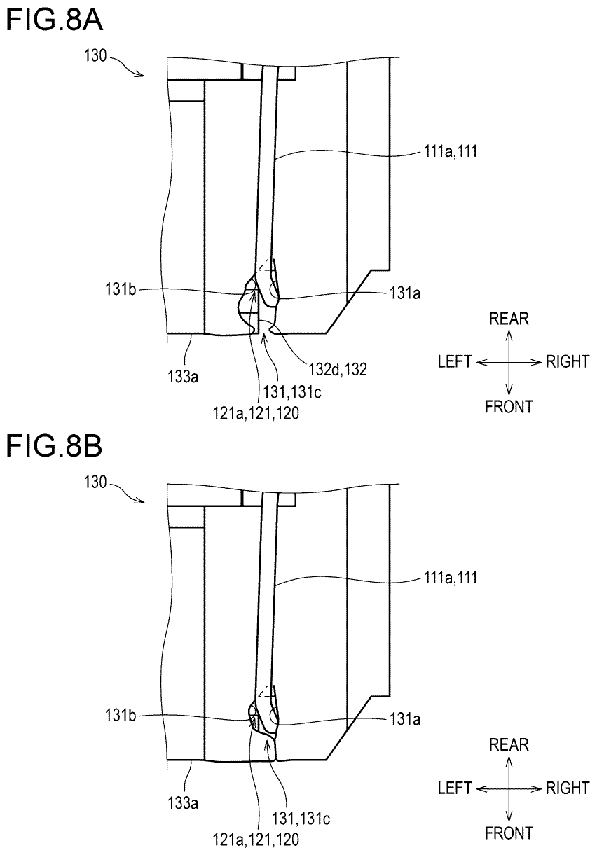

FIG. 8A is an enlarged view of a top view for showing an example of a first arrangement portion 131 in a coil device 100 according to the present embodiment.

First, an overview of the coil device 100 according to the present embodiment will be described.

In a similar manner to the first embodiment, the coil device 100 includes a coil 110 and a chip capacitor 120. A coil wire is wound around the coil 110. The chip capacitor 120 electrically connects to the coil 110 and has an electrode surface 121a. The electrode surface 121a is a surface of an electrode of the chip capacitor 120. A connecting portion 111b is a partial length region of the coil wire 111 extracted from the coil 110. The connecting portion 111b is directly connected to the electrode surface 121a.

The coil device 100 further includes a base portion 130 that holds the chip capacitor 120. The base portion 130 has a first side portion 133 and a second side portion 134. The first side portion 133 covers a first covered surface 122 of the surface of the chip capacitor 120. The second side portion 134 covers a second covered surface 123 of the surface of the chip capacitor 120.

The connecting portion 111b of the coil wire 111 bridges between a first arrangement portion 131 and a second arrangement portion 132. The first arrangement portion 131 and the second arrangement portion 132 are arranged across a part of the chip capacitor 120. The first arrangement portion 131 and the second arrangement portion 132 are formed in the first side portion 133 or the second side portion 134, respectively.

Next, the coil device 100 according to the present embodiment will be described in detail.

In a similar manner to the first embodiment, the first arrangement portion 131 is a part of the base portion 130 (notch forming portion 131) which demarcates a notched portion 131c through which the coil wire 111 passes.

The coil device 100 according to the present embodiment differs from the first embodiment described above in that the width of the notched portion 131c formed by the notch forming portion 131 is narrower toward an opening portion of the notched portion 131c. In other words, the notched portion 131c according to the present embodiment has a constricted opening portion. Specifically, a width at the opening portion of the notch forming portion 131 (a separation distance between parts of the notch forming portion 131) is smaller than a width of the notched portion 131c at a predetermined position in the front-rear direction. Preferably, an opening width of the opening portion of the notch forming portion 131 is smaller than a diameter of the coil wire 111. Accordingly, the coil wire 111 may be prevented from detaching from the notch forming portion 131 and the connection between the connecting portion 111b and the electrode surface 121a may be maintained in a favorable manner.

While the notch forming portion 131 is separated from a large portion of a peripheral surface of the coil wire 111 in the present embodiment, the notch forming portion 131 is not limited thereto. The notch forming portion 131 may be arranged so as to come into close contact or into contact with a part of the peripheral surface of the coil wire 111. Due to the notch forming portion 131 being arranged in contact with the coil wire 111 in this manner, the notch forming portion 131 may more favorably hold the coil wire 111.

In the present embodiment, the notched portion 131c is demarcated by a first wall portion that forms a left side of the notched portion 131c, a second wall portion that forms a right side of the notched portion 131c, and a bottom portion. A part on the bottom portion side of the first wall portion (inclined surface portion 131b) and a part on the bottom portion side of the second wall portion (upright portion 131a) differ from each other in terms of angles formed with respect to a first end surface 133a. Specifically, in a similar manner to the first embodiment, the angle formed by the upright portion 131a with respect to the first end surface 133a is greater than the angle formed by the inclined surface portion 131b with respect to the first end surface 133a.

The notch forming portion 131 according to the present embodiment may be formed as follows. For example, first, a wide notched portion 131c is formed in the base portion 130 and the coil wire 111 is arranged inside the notched portion 131c. Subsequently, a shape of the notch forming portion 131 according to the present embodiment may be formed by deforming an opening end of the notch forming portion 131 so as to constrict the opening end by applying stress to the opening end of the notch forming portion 131, thermally metamorphosing the opening end, or the like. When thermally metamorphosing the opening end of the notch forming portion 131, heat of the brazing material 140 for brazing the connecting portion 111b and the electrode surface 121a to each other may be used. In other words, the opening end of the notch forming portion 131 may be deformed by bringing the opening end of the notch forming portion 131 close to the heated brazing material 140 or immersing the opening end of the notch forming portion 131 in the heated brazing material 140. Alternatively, the notched portion 131c with a constricted opening may be formed in the base portion 130 in advance and the coil wire 111 may be press-fitted into the notched portion 131c by pressing the coil wire 111 against the opening portion of the notch forming portion 131.

The chip capacitor 120 is arranged more to one side (forward) in the winding axis direction of the coil 110 than the coil 110. In addition, the connecting portion 111b is arranged on a surface of the electrode surface 121a that faces forward. In the present embodiment, the electrode surface 121a is arranged more forward than the coil wire 111 arranged in the first arrangement portion 131 or the second arrangement portion 132. Accordingly, the coil wire 111 (connecting portion 111b) may be brought into contact with the electrode surface 121a in a favorable manner.

In this case, the coil wire 111 being arranged in the first arrangement portion 131 or the second arrangement portion 132 particularly refers to the coil wire 111 arranged in contact with the bottom portion of the notch forming portion 131 or a vicinity thereof or the coil wire 111 arranged in contact with the turning bottom portion 132b (refer to FIG. 5 according to the first embodiment) of the turning portion 132 or a vicinity thereof. In other words, the electrode surface 121a is arranged more forward than the bottom portion of the notch forming portion 131 or the turning bottom portion 132b (refer to FIG. 5) of the turning portion 132.

In a similar manner to the coil device 100 according to the first embodiment, the coil device 100 according to the present embodiment has the following features.

In the present embodiment, the electrode surface 121a of the chip capacitor 120 and the connecting portion 111b are brazed together by the brazing material 140. A part of the brazing material 140 is arranged between the coil wire 111 and each of the first arrangement portion 131 and the second arrangement portion 132.

The chip capacitor 120 is arranged on one side (forward side) of the coil 110 in the winding axis direction of the coil 110 (front-rear direction). The second covered surface 123 which is covered by the second side portion 134 extends in the winding axis direction. The second side portion 134 has the fixing portion 135 to which one end of the coil wire 111 is fixed. The fixing portion 135 when viewed in the winding axis direction is formed more centrally than the second arrangement portion 132 in the width direction of the coil device 100 in the second side portion 134.

In addition, in a similar manner to the first embodiment, the base portion 130 according to the present embodiment may be provided separated from the coil 110 and the like.

The chip capacitor holder (base portion 130) has a mounting portion (housing depression 139) for mounting a chip capacitor, the first side portion 133, and the second side portion 134. The first side portion 133 and the second side portion 134 are separated from and face each other across the mounting portion.

The notched portion 131c is formed on the end surface of the first side portion 133. Another notched portion (wire arrangement depression 132d) is formed on the end surface of the second side portion 134. The notched portion 131c and the wire arrangement depression 132d overlap with each other when viewed in a separation direction of the first side portion 133 and the second side portion 134 (up-down direction).

In a similar manner to the first embodiment, the coil device 100 according to the present embodiment is manufactured by the following method.

The coil wire 111 is extracted from the coil 110 and the connecting portion 111b is directly connected to the electrode surface 121a.

More specifically, the connecting portion 111b is arranged so as to bridge between the first arrangement portion and the second arrangement portion. As described above, the first arrangement portion 131 and the turning portion 132 are parts of the base portion 130 and are arranged across a part of the electrode surface. The connecting portion 111b is arranged so as to come into pressurized contact with the electrode surface 121a and, in this arranged state, the connecting portion 111b is connected to the electrode surface 121a.

### Third Embodiment

FIG. 8B is an enlarged view of a top view for showing an example of a first arrangement portion 131 in a coil device 100 according to the present embodiment.

First, an overview of the coil device 100 according to the present embodiment will be described.

In a similar manner to the first embodiment, the coil device 100 includes a coil 110 and a chip capacitor 120. A coil wire is wound around the coil 110. The chip capacitor 120 electrically connects to the coil 110 and has an electrode surface 121a. The electrode surface 121a is a surface of an electrode of the chip capacitor 120. A connecting portion 111b is a partial length region of the coil wire 111 extracted from the coil 110. The connecting portion 111b is directly connected to the electrode surface 121a.

The coil device 100 further includes a base portion 130 that holds the chip capacitor 120. The base portion 130 has a first side portion 133 and a second side portion 134. The first side portion 133 covers a first covered surface 122 of the surface of the chip capacitor 120. The second side portion 134 covers a second covered surface 123 of the surface of the chip capacitor 120.

The connecting portion 111b of the coil wire 111 bridges between a first arrangement portion 131 and a second arrangement portion 132. The first arrangement portion 131 and the second arrangement portion 132 are arranged across a part of the chip capacitor 120. The first arrangement portion 131 and the second arrangement portion 132 are formed in the first side portion 133 or the second side portion 134, respectively.

Next, the coil device 100 according to the present embodiment will be described in detail.

The coil device 100 according to the present embodiment differs from the first embodiment and the second embodiment described above in that a periphery of a part of the coil wire 111 arranged in the first arrangement portion 131 is surrounded by the base portion 130. The first arrangement portion 131 according to the present embodiment is a hole forming portion 131 which forms a hole portion 131c into which the coil wire 111 is to be inserted. In the present embodiment, the first arrangement portion 131 which forms the hole portion 131c has a cut on a forward side. In other words, there is substantially no gap between parts of the first arrangement portion 131 that form the hole portion 131c and the parts are in contact with each other on the forward side of the hole portion 131c. Instead of the present embodiment, the first arrangement portion 131 may integrally form the periphery of the hole portion 131c without the cut.

Due to the coil wire 111 passing through the hole portion 131c in this manner, the coil wire 111 is prevented from detaching from the base portion 130 and the connection between the connecting portion 111b and the electrode surface 121a is maintained in a favorable manner.

In the present embodiment, the hole portion 131c is demarcated by a first peripheral wall portion that forms a left side of the hole portion 131c and a second peripheral wall portion that forms a right side of the hole portion 131c. A part on the rearward side of the first peripheral wall portion (inclined surface portion 131b) and a part on the rearward side of the second peripheral wall portion (upright portion 131a) differ from each other in terms of angles formed with respect to the first end surface 133a. Specifically, in a similar manner to the first embodiment, the angle formed by the upright portion 131a with respect to the first end surface 133a is greater than the angle formed by the inclined surface portion 131b with respect to the first end surface 133a.

The hole forming portion 131 according to the present embodiment may be formed in a similar manner to the second embodiment. Specifically, first, a wide notched portion is formed in the base portion 130 and the coil wire 111 is arranged inside the notched portion. Subsequently, the hole portion 131c according to the present embodiment may be formed by deforming an opening end of the notched portion so as to close the opening end by applying stress to the opening end of the notched portion, thermally metamorphosing the opening end, or the like. Alternatively, the hole portion 131c may be formed by closing the opening portion of the notched portion by further piling a resin onto the opening end of the notched portion. Alternatively, the hole forming portion 131 may be formed in the base portion 130 and the coil wire 111 may be inserted into the hole portion 131c when routing the coil wire 111 in the base portion 130.

The chip capacitor 120 is arranged more to one side (forward) in the winding axis direction of the coil 110 than the coil 110. In addition, the connecting portion 111b is arranged on a surface of the electrode surface 121a that faces forward. In the present embodiment, the electrode surface 121a is arranged more forward than the coil wire 111 arranged in the first arrangement portion 131 or the second arrangement portion 132. Accordingly, the coil wire 111 (connecting portion 111b) may be brought into contact with the electrode surface 121a in a favorable manner.

In this case, the coil wire 111 being arranged in the first arrangement portion 131 or the second arrangement portion 132 particularly refers to the coil wire 111 arranged in contact with the hole portion or a vicinity thereof or the coil wire 111 arranged in contact with the turning bottom portion 132b (refer to FIG. 5 according to the first embodiment) of the turning portion 132 or a vicinity thereof. In other words, the electrode surface 121a is arranged more forward than the hole portion 131c demarcated in the hole forming portion 131 or the turning bottom portion 132b (refer to FIG. 5) of the turning portion 132.

In a similar manner to the coil device 100 according to the first embodiment, the coil device 100 according to the present embodiment has the following features.

In the present embodiment, the electrode surface 121a of the chip capacitor 120 and the connecting portion 111b are brazed together by the brazing material 140. A part of the brazing material 140 is arranged between the coil wire 111 and each of the first arrangement portion 131 and the second arrangement portion 132.

The chip capacitor 120 is arranged on one side (forward side) of the coil 110 in the winding axis direction of the coil 110 (front-rear direction). The second covered surface 123 which is covered by the second side portion 134 extends in the winding axis direction. The second side portion 134 has the fixing portion 135 to which one end of the coil wire 111 is fixed. The fixing portion 135 when viewed in the winding axis direction is formed more centrally than the second arrangement portion 132 in the width direction of the coil device 100 in the second side portion 134.

In addition, in a similar manner to the first embodiment, the base portion 130 according to the present embodiment may be provided separated from the coil 110 and the like.

The chip capacitor holder (base portion 130) has a mounting portion (housing depression 139) for mounting a chip capacitor, the first side portion 133, and the second side portion 134. The first side portion 133 and the second side portion 134 are separated from and face each other across the mounting portion.

A notched portion is formed on the end surface of the first side portion 133. Another notched portion (a space demarcated by the turning portion 132) is formed on the end surface of the second side portion 134. The notched portion and the other notched portion overlap with each other when viewed in a separation direction of the first side portion 133 and the second side portion 134.

In a similar manner to the first embodiment, the coil device 100 according to the present embodiment is manufactured by the following method.

The coil wire 111 is extracted from the coil 110 and the connecting portion 111b is directly connected to the electrode surface 121a.

More specifically, the connecting portion 111b is arranged so as to bridge between the first arrangement portion and the second arrangement portion. As described above, the first arrangement portion 131 and the turning portion 132 are parts of the base portion 130 and are arranged across a part of the electrode surface. The connecting portion 111b is arranged so as to come into pressurized contact with the electrode surface 121a and, in this arranged state, the connecting portion 111b is connected to the electrode surface 121a.

The present invention is not limited to the embodiments described above and includes aspects of various modifications, improvements, and the like insofar as the object of the present invention is achieved. Hereinafter, the first to third embodiments may be collectively referred to as the present embodiment.

The modifications described below may be appropriately combined with one another.

While the coil wire 111 is in contact with the turning portion 132 (in particular, the contact portion 132c) in the present embodiment, the coil wire 111 may be separated from the turning portion 132. Even in this case, the coil wire 111 is preferably bent in a part in proximity to the turning portion 132. In addition, the turning portion 132 preferably forms a predetermined angle around a part in proximity to the bent part of the coil wire 111 (a part corresponding to the contact portion 132c in the embodiments described above), and the angle is preferably greater than an angle formed between a pair of wall portions that demarcate the notched portion 131c.

The embodiments described above cover the following technical ideas.
(1) A coil device, including: a coil around which a coil wire is wound; and a chip capacitor which electrically connects to the coil and which has an electrode surface, wherein
a connecting portion which is a partial length region of the coil wire extracted from the coil is directly connected to the electrode surface.
(2) The coil device according to (1), further including: a base portion which holds the chip capacitor, wherein
the base portion has a first side portion which covers a partial region of a surface of the chip capacitor and a second side portion which covers another partial region of the surface of the chip capacitor, and
the connecting portion of the coil wire bridges between a first arrangement portion and a second arrangement portion which are arranged across a part of the chip capacitor and which are each formed in the first side portion or the second side portion.
(3) The coil device according to (2), wherein the first arrangement portion is a part of the base portion which demarcates a notched portion through which the coil wire is to pass,
the second arrangement portion is a turning portion at which the coil wire comes into contact with and bends, and
an angle formed by the turning portion around a part which the coil wire is in contact with in the turning portion is greater than an angle formed between a pair of wall portions which demarcate the notched portion.
(4) The coil device according to (3), wherein an angle formed by one of the wall portions with respect to an end surface of the first side portion on which the notched portion is provided is greater than an angle formed by the other wall portion with respect to the end surface of the first side portion, and
the one of the wall portions and the turning portion are arranged across the connecting portion when viewed in an extension direction of the connecting portion.
(5) The coil device according to any one of (2) to (4), wherein a part of the electrode surface when viewed facing the partial region or the another partial region is exposed from an end portion including the first arrangement portion or the second arrangement portion in the base portion.
(6) The coil device according to (2), wherein the first arrangement portion is a part of the base portion which demarcates a notched portion through which the coil wire is to pass, and
a width of the notched portion becomes narrower toward an opening portion of the notched portion.
(7) The coil device according to (2), wherein a periphery of a part of the coil wire arranged in the first arrangement portion is covered by the base portion.
(8) The coil device according to (6) or (7), wherein the chip capacitor is arranged more to one side in a winding axis direction of the coil than the coil,
the connecting portion is arranged on a surface of the electrode surface facing the one side, and the electrode surface is arranged more to the one side
than the first arrangement portion or the second arrangement portion.
(9) The coil device according to any one of (2) to (8), wherein the electrode surface of the chip capacitor and the connecting portion are brazed together by a brazing material, and
a part of the brazing material is arranged between the coil wire and the first arrangement portion or the second arrangement portion.
(10) The coil device according to any one of (2) to (9), wherein the chip capacitor is arranged on one side of the coil in a winding axis direction of the coil,
the another partial region covered by the second side portion extends in the winding axis direction,
the second side portion has a fixing portion to which one end of the coil wire is fixed, and
the fixing portion when viewed in the winding axis direction is formed more centrally than the second arrangement portion in a width direction of the coil device in the second side portion.
(11) A chip capacitor holder, including: a mounting portion for mounting a chip capacitor; and
a first side portion and a second side portion which are separated from and face each other across the mounting portion, wherein
a notched portion is formed on an end surface of the first side portion,
another notched portion is formed on an end surface of the second side portion, and
the notched portion and the another notched portion overlap with each other when viewed in a separation direction of the first side portion and the second side portion.
(12) A method of manufacturing a coil device including a coil around which a coil wire is wound and a chip capacitor which electrically connects to the coil and which has an electrode surface, wherein
the coil wire is extracted from the coil and a connecting portion which is a partial length region of the extracted coil wire is directly connected to the electrode surface.
(13) The method of manufacturing a coil device according to (12), the coil device further including a base portion which holds the chip capacitor, wherein
the connecting portion of the coil wire is arranged so as to bridge between a first arrangement portion and a second arrangement portion which are parts of the base portion and which are arranged across a part of the electrode surface, and
the connecting portion is connected to the electrode surface in a state where the connecting portion is arranged so as to come into pressurized contact with the electrode surface.

1. A coil device, comprising: a coil around which a coil wire is wound; and a chip capacitor which electrically connects to the coil and which has an electrode surface, wherein
a connecting portion which is a partial length region of the coil wire extracted from the coil is directly connected to the electrode surface.

2. The coil device according to claim 1, further comprising: a base portion which holds the chip capacitor, wherein
the base portion has a first side portion which covers a partial region of a surface of the chip capacitor and a second side portion which covers another partial region of the surface of the chip capacitor, and
the connecting portion of the coil wire bridges between a first arrangement portion and a second arrangement portion which are arranged across a part of the chip capacitor and which are each formed in the first side portion or the second side portion.

3. The coil device according to claim 2, wherein the first arrangement portion is a part of the base portion which demarcates a notched portion through which the coil wire is to pass,
the second arrangement portion is a turning portion at which the coil wire comes into contact with and bends, and
an angle formed by the turning portion around a part which the coil wire is in contact with in the turning portion is greater than an angle formed between a pair of wall portions which demarcate the notched portion.

4. The coil device according to claim 3, wherein an angle formed by one of the wall portions with respect to an end surface of the first side portion on which the notched portion is provided is greater than an angle formed by the other wall portion with respect to the end surface of the first side portion, and
the one of the wall portions and the turning portion are arranged across the connecting portion when viewed in an extension direction of the connecting portion.

5. The coil device according to claim 2, wherein a part of the electrode surface when viewed facing the partial region or the another partial region is exposed from an end portion including the first arrangement portion or the second arrangement portion in the base portion.

6. The coil device according to claim 2, wherein the first arrangement portion is a part of the base portion which demarcates a notched portion through which the coil wire is to pass, and
a width of the notched portion becomes narrower toward an opening portion of the notched portion.

7. The coil device according to claim 2, wherein a periphery of a part of the coil wire arranged in the first arrangement portion is covered by the base portion.

8. The coil device according to claim 6, wherein the chip capacitor is arranged more to one side in a winding axis direction of the coil than the coil,
the connecting portion is arranged on a surface of the electrode surface facing the one side, and
the electrode surface is arranged more to the one side than the first arrangement portion or the second arrangement portion.

9. The coil device according to claim 2, wherein the electrode surface of the chip capacitor and the connecting portion are brazed together by a brazing material, and
a part of the brazing material is arranged between the coil wire and the first arrangement portion or the second arrangement portion.

10. The coil device according to claim 2, wherein the chip capacitor is arranged on one side of the coil in a winding axis direction of the coil,
the another partial region covered by the second side portion extends in the winding axis direction,
the second side portion has a fixing portion to which one end of the coil wire is fixed, and
the fixing portion when viewed in the winding axis direction is formed more centrally than the second arrangement portion in a width direction of the coil device in the second side portion.

11. A chip capacitor holder, comprising:
a mounting portion for mounting a chip capacitor; and
a first side portion and a second side portion which are separated from and face each other across the mounting portion, wherein
a notched portion is formed on an end surface of the first side portion,
another notched portion is formed on an end surface of the second side portion, and
the notched portion and the another notched portion overlap with each other when viewed in a separation direction of the first side portion and the second side portion.

12. A method of manufacturing a coil device including a coil around which a coil wire is wound and a chip capacitor which electrically connects to the coil and which has an electrode surface, wherein
the coil wire is extracted from the coil and a connecting portion which is a partial length region of the extracted coil wire is directly connected to the electrode surface.

13. The method of manufacturing a coil device according to claim 12, the coil device further including a base portion which holds the chip capacitor, wherein
the connecting portion of the coil wire is arranged so as to bridge between a first arrangement portion and a second arrangement portion which are parts of the base portion and which are arranged across a part of the electrode surface, and
the connecting portion is connected to the electrode surface in a state where the connecting portion is arranged so as to come into pressurized contact with the electrode surface.
